(19) United States
(12) Patent Application Publication
(10) Pub. No.: US 2013/0179022 A1
(43) Pub. Date: Jul. 11, 2013

(54) REGENERATION CONTROL DEVICE, HYBRID VEHICLE, REGENERATION CONTROL METHOD, AND PROGRAM

(71) Applicant: Hirotaka Ueno, Tokyo (JP)

(72) Inventor: Hirotaka Ueno, Tokyo (JP)

(73) Assignee: HINO MOTORS, LTD., Tokyo (JP)

(21) Appl. No.: 13/876,511

(22) PCT Filed: Oct. 20, 2011
(86) PCT No.: PCT/JP2011/074178

§ 371 Date: Mar. 28, 2013

(30) Foreign Application Priority Data
Oct. 21, 2010 (JP) 2010-236611

(51) Int. Cl. B60W 10/196; B60W 10/06; B60W 20/00

(52) U.S. Cl. CPC B60W 10/196; B60W 20/00; B60W 10/06; B60W 2600/00; Y10S 903/93
USPC 701/22; 180/65.265; 903/930

(57) ABSTRACT

In order to finish the regeneration step in a short time and improve fuel efficiency, a regeneration control device for a post-processing device of a hybrid vehicle is constructed such that, at the time of deceleration during the regeneration of the post-processing device, the hybrid vehicle is driven by the electric motor, and the engine is controlled so as to retain a rotation speed suitable for the regeneration of the post-processing device in a manner irrelevant to the driving system, and a control force equivalent to the braking force provided by the engine brake is generated by the recovery of the electric motor.

### CROSS REFERENCE TO RELATED APPLICATIONS

This is a U.S. national stage of application No. PCT/JP2011/074178, filed on Oct. 20, 2011. Priority under 35 U.S.C.§119(a) and 35 U.S.C.§365(b) is claimed from Japanese Patent Application No. 2010-236611, filed on Oct. 21, 2010, the disclosure of which are also incorporated herein by reference.

### TECHNICAL FIELD

The present invention relates to a regeneration control device, a hybrid vehicle, a regeneration control method, and a computer program.

### BACKGROUND ART

A vehicle having a diesel engine includes a post-processing device for removing, for example, the particulate matter contained in the exhaust gas. Such a post-processing device needs implementation of a process called “regeneration” in which the engine is operated under high load to burn off the particulate matter accumulated in a filter in order to prevent the filter to get clogged (for example, see patent literature PTL1).

### CITATION LIST

### Patent Literature

PTL1: JP 2006-275009 A

During the implementation of the above-mentioned “regeneration”, the engine needs to be operated under high load. However, when the engine braking is used, for example, when the vehicle runs on a long downgrade, the fuel supply to the engine needs to be halted, and thus the process of the “regeneration” is suspended during that time.

Once the process of the “regeneration” is suspended as described above, the temperature of the post-processing device decreases. This requires time to increase the temperature of the post-processing device again and delays the completion of the “regeneration”. Further, the “regeneration” requires the high load operation of the engine and thus the prolongation of the “regeneration” causes the fuel efficiency to become worse.

In light of the foregoing, an objective of the present invention is to provide a regeneration control device, a hybrid vehicle, a regeneration control method, and a computer program that completes the process of “regeneration” in a short time so that the fuel efficiency can be improved.

### Solution to Problem

An aspect of the present invention relates to a regeneration control device. According to the present invention, there is provided a regeneration control device of a post-processing device in a hybrid vehicle that includes an engine and an electric motor and that is capable of running by the engine or the electric motor or capable of running by a cooperation between the engine and the electric motor, that is capable of performing regenerative power generation with the electric motor at least during deceleration, and that includes the post-processing device for exhaust gas. The regeneration control device, when the vehicle decelerates during the regeneration of the post-processing device, causes the vehicle to run with the electric motor, controls the engine to maintain a rotational speed appropriate for the regeneration of the post-processing device independently from a driving system, and generates braking force equivalent to braking force of engine braking by the regeneration with the electric motor.

Further, the exhaust brake may be operated during the regeneration of the post-processing device.

Another aspect of the present invention relates to a hybrid vehicle including the regeneration control device according to the present invention.

Another aspect of the present invention relates to a regeneration control method. According to the present invention, there is provided a regeneration control method of a post-processing device in a hybrid vehicle that includes an engine and an electric motor and that is capable of running by the engine or the electric motor or capable of running by a cooperation between the engine and the electric motor, that is capable of performing regenerative power generation with the electric motor at least during deceleration, and that includes the post-processing device for exhaust gas. The regeneration control method, when the vehicle decelerates during the regeneration of the post-processing device, is a method for causing the vehicle to run with the electric motor, controlling the engine to maintain a rotational speed appropriate for the regeneration of the post-processing device independently from a driving system, and generating braking force equivalent to braking force of engine braking by the regeneration with the electric motor while the engine braking is required.

Another aspect of the present invention relates to a computer program for causing an information processing apparatus to implement a function equivalent to a function of the regeneration control device according to the present invention.

### Advantageous Effects of Invention

According to the present invention, the process of “regeneration” is completed in a short time so that the fuel efficiency can be improved.

### BRIEF DESCRIPTION OF DRAWINGS

FIG. 1 is a block diagram for illustrating an exemplary structure of a hybrid vehicle according to an embodiment of the present invention.

FIG. 2 is a block diagram for illustrating an exemplary configuration of a function implemented in a hybrid ECU illustrated in FIG. 1.

FIG. 3 is a flowchart for illustrating a regeneration control process by a post-processing device regeneration control unit illustrated in FIG. 2.

### DESCRIPTION OF EMBODIMENTS

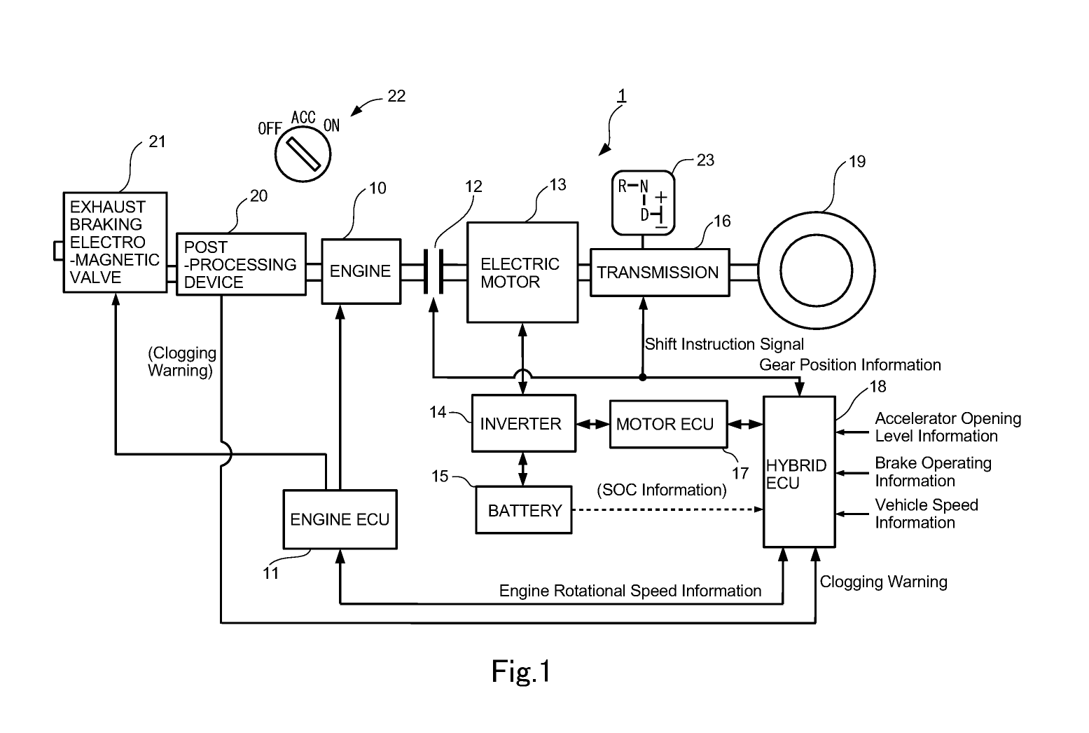

Hereinafter, the hybrid vehicle according to an embodiment of the present invention will be described with reference to FIGS. 1 to 3.

### [Outline]

A hybrid vehicle includes an engine and an electric motor and can run with the engine or the electric motor, or can run by the cooperation between the engine and the electric motor, and thus can use the regeneration torque of the electric motor as braking force instead of the engine braking. Accordingly, in the hybrid vehicle 1 according to the embodiment of the present invention, when the vehicle decelerates during the “regeneration” of the post-processing device, the regeneration torque of the electric motor provides braking force equivalent to the engine braking and the engine continues the high load operation for the “regeneration” even if the engine braking is required.

### Embodiment of the Present Invention

FIG. 1 is a block diagram for illustrating an exemplary structure of a hybrid vehicle 1. The hybrid vehicle 1 is an example of a vehicle.

The hybrid vehicle 1 includes the engine 10, an engine Electronic Control Unit (ECU) 11, a clutch 12, the electric motor 13, an inverter 14, a battery 15, a transmission 16, a motor ECU 17, a hybrid ECU 18, a wheel 19, a post-processing device 20, an exhaust braking electromagnetic valve 21, a key switch 22, and a shift unit 23. The transmission 16 includes an automated mechanical/manual transmission, and is operated by the shift unit 23 including a drive range (hereinafter, referred to as a D (Drive) range). Note that the automated mechanical/manual transmission is a transmission that can automatically perform a gear shifting operation while having the same structure as a manual transmission. Further, the “driving system” in claims includes, for example, the clutch 12, the electric motor 13, the transmission 16, and the wheel 19.

The engine 10 is an example of an internal combustion engine, and is controlled by the engine ECU 11. The engine 10 internally combusts gasoline, light oil, Compressed Natural Gas (CNG), Liquefied Petroleum Gas (LPG), alternative fuel, or the like in order to generate power for rotating a shaft and transmit the generated power to the clutch 12.

The engine ECU 11 is a computer working in coordination with the motor ECU 17 according to the instructions from the hybrid ECU 18, and controls the engine 10, for example, the amount of fuel injection and the valve timing. For example, the engine ECU 11 includes a Central Processing Unit (CPU), an Application Specific Integrated Circuit (ASIC), a microprocessor (micro-computer), a Digital Signal Processor (DSP), and the like, and internally has an operation unit, a memory, an Input/Output (I/O) port, and the like.

The clutch 12 is controlled by the hybrid ECU 18, and transmits the shaft output from the engine 10 to the wheel 19 through the electric motor 13 and the transmission 16. In other words, the clutch 12 mechanically connects the rotating shaft of the engine 10 to the rotating shaft of the electric motor 13 by the control of the hybrid ECU 18 in order to transmit the shaft output of the engine 10 to the electric motor 13. On the other hand, the clutch 12 cuts the mechanical connection between the rotating shaft of the engine 10 and the rotating shaft of the electric motor 13 so that the shaft of the engine 10 and the rotating shaft of the electric motor 13 can rotate at different rotational speeds from each other.

For example, the clutch 12 mechanically connects the rotating shaft of the engine 10 to the rotating shaft of the electric motor 13, for example, when the hybrid vehicle 1 runs by the power of the engine 10 and this causes the electric motor 13 to generate electric power, when the driving force of the electric motor 13 assists the engine 10, and when the electric motor 13 starts the engine 10.

Further, for example, the clutch 12 cuts the mechanical connection between the rotating shaft of the engine 10 and the rotating shaft of the electric motor 13 when the engine 10 stops or is in an idling state and the hybrid vehicle 1 runs by the driving force of the electric motor 13, and when the hybrid vehicle 1 reduces the speed or runs on the downgrade and the electric motor 13 generates (regenerates) electric power while the engine 10 stops or is in an idling state.

Note that the clutch 12 differs from a clutch operated by the driver's operation of a clutch pedal, and is operated by the control of the hybrid ECU 18.

The electric motor 13 is a so-called motor generator that supplies a shaft output to the transmission 16 by generating the power for rotating the shaft using the electric power supplied from the inverter 14, or that supplies electric power to the inverter 14 by generating the electric power using the power for rotating the shaft supplied from the transmission 16. For example, when the hybrid vehicle 1 gains the speed or runs at a constant speed, the electric motor 13 generates the power for rotating the shaft to supply the shaft output to the transmission 16 in order to cause the hybrid vehicle 1 to run in cooperation with the engine 10. Further, the electric motor 13 works as an electric generator, for example, when the electric motor 13 is driven by the engine 10, or when the hybrid vehicle 1 runs without power, for example, when the hybrid vehicle 1 reduces the speed or runs on the downgrade. In that case, electric power is generated by the power for rotating the shaft supplied from the transmission 16 and is supplied to the inverter 14 in order to charge the battery 15.

The inverter 14 is controlled by the motor ECU 17, and converts the direct voltage from the battery 15 into an alternating voltage or converts the alternating voltage from the electric motor 13 into a direct voltage. When the electric motor 13 generates power, the inverter 14 converts the direct voltage from the battery 15 into an alternating voltage and supplies the electric power to the electric motor 13. When the electric motor 13 generates electric power, the inverter 14 converts the alternating voltage from the electric motor 13 into a direct voltage. In other words, in that case, the inverter 14 works as a rectifier and a voltage regulator for supplying a direct voltage to the battery 15.

The battery 15 is a secondary cell capable of being charged and discharged. The battery 15 supplies electric power to the electric motor 13 through the inverter 14 when the electric motor 13 generates power. Alternatively, the battery 15 is charged with the electric power generated by the electric motor 13 when the electric motor 13 generates electric power.

The transmission 16 includes an automated mechanical/manual transmission (not shown in the drawings) that selects one of a plurality of gear ratios (change gear ratios) according to the shift instruction signal to shift gears from the hybrid ECU 18 in order to shift the change gear ratios and transmit the gear-shifted power of the engine 10 and/or of the electric motor 13 to the wheel 19. Alternatively, the transmission 16 transmits the power from the wheel 19 to the electric motor 13, for example, when the vehicle reduces the speed or runs on the downgrade. Note that the automated mechanical/manual transmission can also shift the gear position to a given gear number by the driver's hand operation of the shift unit 23.

The motor ECU 17 is a computer working in coordination with the engine ECU 11 according to the instructions from the hybrid ECU 18, and controls the electric motor 13 by controlling the inverter 14. For example, the motor ECU 17 includes a CPU, an ASIC, a microprocessor (micro-computer), a DSP, and the like, and internally has an operation unit, a memory, an I/O port, and the like.

The hybrid ECU 18 is an example of a computer. For hybrid running, the hybrid ECU 18 obtains accelerator opening information, brake operation information, vehicle speed information, the gear position information obtained from the transmission 16, and the engine rotational speed information obtained from the engine ECU 11 in order to refer to the information, control the clutch 12 and supply the shift instruction signal to shift gears in order to control the transmission 16. For hybrid running, the hybrid ECU 18 further gives the instructions to the motor ECU 17 to control the electric motor 13 and the inverter 14 based on the obtained State of Charge (SOC) information on the battery 15 and other information, and gives the instruction to the engine ECU 11 to control the engine 10. Further, once receiving a “clogging warning” sent from the post-processing device 20, the hybrid ECU 18 gives instructions for implementing the process for “regeneration” to the engine ECU 11, the clutch 12, and the motor ECU 17. For example, the hybrid ECU 18 includes a CPU, an ASIC, a microprocessor (micro-computer), a DSP, and the like, and internally has an operation unit, a memory, an I/O port, and the like.

Note that a computer program to be executed by the hybrid ECU 18 can be installed on the hybrid ECU 18 that is a computer in advance by being stored in a non-volatile memory inside the hybrid ECU 18 in advance.

The engine ECU 11, the motor ECU 17, and the hybrid ECU 18 are connected to each other, for example, through a bus complying with the standard of the Control Area Network (CAN) or the like.

The wheel 19 is a drive wheel for transmitting the driving force to the road surface. Note that, although only a wheel 19 is illustrated in FIG. 1, the hybrid vehicle 1 actually includes a plurality of the wheels 19.

The post-processing device 20 is for cleaning up the exhaust gas from the engine 10 and sends the clogging warning of a filter (not illustrated in the drawings) to the hybrid ECU 18. To prevent the filter from getting clogged, it is necessary to implement the process for “regeneration” with operating the engine 10 under high load when the filter almost gets clogged. Note that the clogging warning is the information warning that the filter can get clogged, so that the filter has not been clogged yet at the time when the clogging warning is sent.

The exhaust braking electromagnetic valve 21 is positioned at an exhaust pipe of the engine 10 provided at the rear part of the post-processing device 20. Closing the exhaust braking electromagnetic valve 21 increases the resistance generated when the exhaust gas is emitted outside. This increases the friction of the engine 10 and thus can increase the effect of the engine braking. In the present embodiment, the exhaust braking electromagnetic valve 21 is not used for increasing the effect of the engine braking but for increasing the load on the engine 10 in order to complete the “generation” in a short time.

The key switch 22 is a switch that is turned ON/OFF, for example, by insertion of a key by the user at the start of drive. Turning ON the key switch activates each unit of the hybrid vehicle 1, and turning OFF the key switch 22 stops each unit of the hybrid vehicle 1.

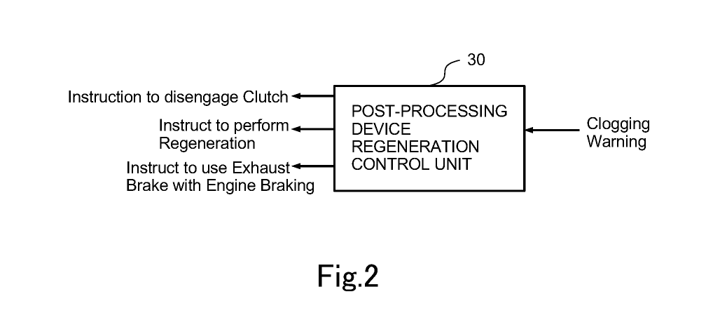

FIG. 2 is a block diagram for illustrating an exemplary configuration of a function implemented in the hybrid ECU 18 executing a computer program. In other words, when the hybrid ECU 18 executes a computer program, a post-processing device regeneration control unit 30 is implemented.

Once receiving the clogging warning from the post-processing device 20, the post-processing device regeneration control unit 30 sends instructions to each part in order to implement the process of the “regeneration”.

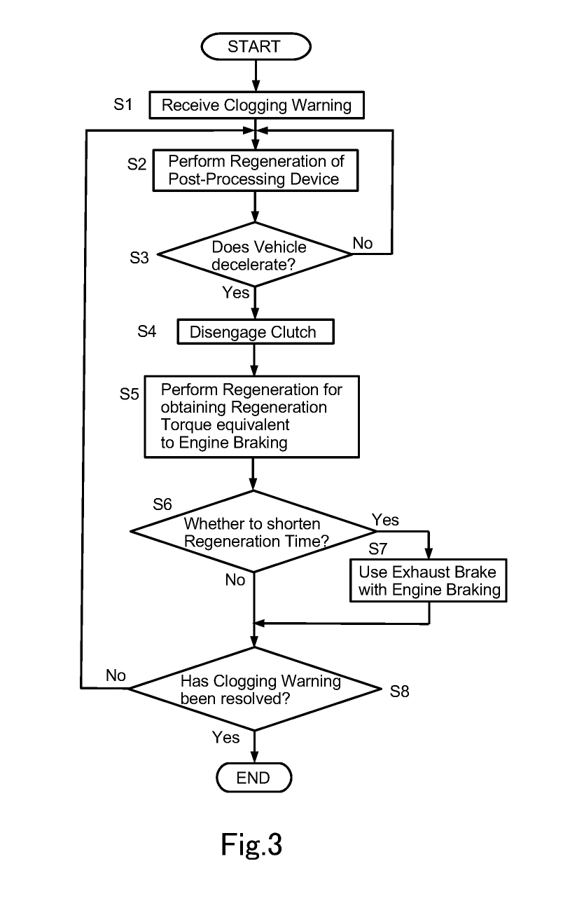

Next, the process for a regeneration control of the post-processing device 20 implemented in the hybrid ECU 18 executing a computer program will be described with reference to the flowchart in FIG. 3.

At the START in FIG. 3, the hybrid ECU 18 has executed a computer program and the post-processing device regeneration control unit 30 is implemented in the hybrid ECU 18. Then, the process goes to step S1. Note that the fact that a value indicating the SOC of the battery 15 is equal to or less than a predetermined value can be added as a condition of the “START” because the regeneration for obtaining the regeneration torque equivalent to the engine braking cannot be performed in step S5 if the value indicating the SOC of the battery 15 is high.

In step S1, when the post-processing device regeneration control unit 30 receives the clogging warning from the post-processing device 20, the process goes to step S2.

In step S2, the post-processing device regeneration control unit 30 performs the “regeneration” and the process goes to step S3.

In step S3, the post-processing device regeneration control unit 30 determines whether the hybrid vehicle 1 reduces the speed. When it is determined in step S3 that the hybrid vehicle 1 reduces the speed, the process goes to step S4. On the other hand, when it is determined in step S3 that the hybrid vehicle 1 does not reduce the speed, the process goes back to step S2.

In step S4, the post-processing device regeneration control unit 30 disengages the clutch 12 and the process goes to step S5.

In step S5, the post-processing device regeneration control unit 30 performs regeneration for obtaining regeneration torque generated by the electric motor 13 and equivalent to the engine braking. Then, the process goes to step S6.

In step S6, the post-processing device regeneration control unit 30 determines whether to shorten the regeneration time. Note that the driver can set the shortening of the regeneration time from a setting unit (not illustrated in the drawings) in advance. When it is determined in step S6 that the regeneration time is shortened, the process goes to step S7. On the other hand, when it is determined in step S6 that it is not necessary to shorten the regeneration time, the process goes to step S8.

In step S7, the post-processing device regeneration control unit 30 closes the exhaust braking electromagnetic valve 21 in order to use the exhaust brake with the engine braking and the process goes to step S8.

In step S8, the post-processing device regeneration control unit 30 determines whether the clogging warning has been resolved. When it is determined in step S8 that the clogging warning has been resolved, the process is terminated. On the other hand, when it is determined in step S8 that the clogging warning has not been resolved yet, the process goes back to step S2.

### [Effects]

when decelerating in the duration of the regeneration of the post-processing device 20, the hybrid vehicle 1 runs with the electric motor 13, controls the engine 10 to maintain a rotational speed appropriate to the regeneration of the post-processing device 20 independently from the driving system, and generates braking force equivalent to the braking force of the engine braking by the regeneration of the electric motor 13. Thus, the engine 10 can continue the high load operation appropriate to the “regeneration” independently from the driving system as long as necessary, so that the process for the “regeneration” can be completed in a short time and the fuel efficiency can be improved.

Further, closing the exhaust braking electromagnetic valve 21 during the regeneration of the post-processing device 20 increases the load on the engine 10 more, and thus can complete the “regeneration” in a shorter time. As described above, completing the “regeneration” in a shorter time can improve the fuel efficiency.

### Other Embodiment

Although the clogging warning sent by the post-processing device 20 causes the post-processing device regeneration control unit 30 to implement the “regeneration” in the above-mentioned description of the embodiment, the “regeneration” can periodically be implemented once every predetermined travel distance or predetermined travel time without using such a clogging warning.

Although the exhaust brake is used with the engine braking for the purpose of shortening the regeneration time in the above-mentioned embodiment, the exhaust braking can further be used with the engine braking for the purpose of regenerating the device with excessively accumulated particulate matter within a predetermined time.

For example, once the post-processing device regeneration control unit 30 receives the clogging warning, regeneration is automatically implemented in the above-mentioned description of the embodiment. On the other hand, the vehicle can have a structure in which the clogging warning is notified also to the driver so that the driver can suspend the implementation of the regeneration. It seems that the driver suspends the implementation of the regeneration for the reason, for example, that the driver performs home delivery with the hybrid vehicle 1 in a quiet residential area and needs to reduce the noise of the regeneration from the engine 10.

In such a case, particulate matter is accumulated in the post-processing device 20 more than in the case in which a normal regeneration process is started. The exhaust braking can be used with the engine braking in order to complete burning off such particulate matter within a normal regeneration process time.

However, it is preferable that the usage of the exhaust braking with the engine braking be not easily allowed because the usage causes the increase in the fuel consumption for the regeneration. For example, a threshold is set for the excess of accumulated particulate matter over the amount of accumulated particulate matter enough to start a normal regeneration so that the exhaust braking is used with the engine braking when the excess exceeds the threshold.

Further, a threshold is provided for the value indicating the SOC of the battery 15 so that the post-processing device regeneration control unit 30 can control the regeneration process. For example, two-stage thresholds B<A are provided for the value indicating the SOC. The threshold A is the upper limit of the value indicating the SOC. The threshold B is a value smaller than threshold A and in which the value indicating the SOC of the battery 15 reaches the threshold A in a relatively short time once a regenerative charge is performed. When the value indicating the SOC is equal to or more than the threshold A in that case, the regenerative charge cannot be performed any more. Thus, the regeneration is halted and the clutch 12 is engaged in order to perform a usual control. Further, if the value indicating the SOC is equal to or more than the threshold B and less than the threshold A, it is highly possible that the value indicating the SOC could reach the threshold A a short time later although the process currently goes without a problem. Thus, Yes is selected in step S6 of the flowchart in FIG. 3 in order to perform a control in step S7 to shorten the regeneration time by using the exhaust braking with the engine braking. This enables the regeneration using the engine braking before the regenerative braking cannot be performed, and thus can reduce the usage of a service brake. Further, when the value indicating the SOC is less than the threshold B, the control as described in the flowchart of FIG. 3 is performed.

Although the engine 10 has been described as an internal combustion engine, the engine 10 can also be a heat engine including an external combustion engine.

Further, while the computer program executed by the hybrid ECU 18 is installed on the hybrid ECU 18 in advance in the above-mentioned descriptions, the computer program can be installed on the hybrid ECU 18 as a computer by attaching removable media recording the computer program (storing the program), for example, to a drive (not shown in the drawings) and storing the computer program read from the removable media in a non-volatile memory inside the hybrid ECU 18 or receiving, with a communication unit (not shown in the drawings), a computer program transmitted through a wired or wireless transmission medium and storing the computer program in a non-volatile memory inside the hybrid ECU 18.

Further, each ECU can be implemented by an ECU combining some or all of the functions of the ECUs. Alternatively, an ECU can newly be provided by the further subdivision of the function of each ECU.

Note that the computer program executed by the computer can be for performing the process in chronological order according to the order described herein or can be for performing the process in parallel or at the necessary timing, for example, when the computer program is invoked.

Further, the embodiments of the present invention are not limited to the above-mentioned embodiment, and can variously be modified without departing from the gist of the invention.

1. A regeneration control device of a post-processing device in a hybrid vehicle that includes an engine and an electric motor and that is capable of running by the engine or the electric motor or capable of running by a cooperation between the engine and the electric motor, that is capable of performing regenerative power generation with the electric motor at least during deceleration, and that includes the post-processing device for exhaust gas, the regeneration control device, when the vehicle decelerates during the regeneration of the post-processing device, causing the vehicle to run with the electric motor, controlling the engine to maintain a rotational speed appropriate for the regeneration of the post-processing device independently from a driving system, and generating braking force equivalent to braking force of engine braking by the regeneration with the electric motor.

2. The regeneration control device according to claim 1,
wherein the exhaust brake is operated during the regeneration of the post-processing device.

3. A hybrid vehicle comprising the regeneration control device according to claim 1.

4. A regeneration control method of a post-processing device in a hybrid vehicle that includes an engine and an electric motor and that is capable of running by the engine or the electric motor or capable of running by a cooperation between the engine and the electric motor, that is capable of performing regenerative power generation with the electric motor at least during deceleration, and that includes the post-processing device for exhaust gas, the regeneration control method, when the vehicle decelerates during the regeneration of the post-processing device, for causing the vehicle to run with the electric motor, controlling the engine to maintain a rotational speed appropriate for the regeneration of the post-processing device independently from a driving system, and generating braking force equivalent to braking force of engine braking by the regeneration with the electric motor.

5. A computer program for causing an information processing apparatus to implement a function equivalent to a function of the regeneration control device according to claim 1.
